(19) United States
(12) Patent Application Publication
(10) Pub. No.: US 2026/0125284 A1
(43) Pub. Date: May 7, 2026

(54) Water Jug Filtration System

(71) Applicant: Jeremy Madvin, Westlake Village, CA (US)

(72) Inventor: Jeremy Madvin, Westlake Village, CA (US)

(21) Appl. No.: 18/979,066

(22) Filed: Dec. 12, 2024

Related U.S. Application Data
(60) Provisional application No. 63/714,976, filed on Nov. 1, 2024.

(51) Int. Cl. C02F 1/00; B01D 29/11; B01D 29/56; C02F 1/66

(52) U.S. Cl. CPC C02F 1/003; B01D 29/11; B01D 29/56; C02F 1/66

(57) ABSTRACT

The present invention relates to a water jug filtration system consisting of a filter, a hose, and a cap. The filter features a mouthpiece that connects to one end of the hose and a connector that attaches to the cap. The hose has two ends: one connects to the filter and the other to a tap or water source. The cap is designed to link the filter with a water jug. When the water source is activated, water flows through the hose into the filter. The system removes impurities and contaminants, delivering clean, filtered or treated water into the jug. A vent in the cap releases excess pressure, preventing overflow and ensuring a steady flow during filtration. This design provides an efficient and reliable method for purifying water

### CROSS-REFERENCE TO RELATED APPLICATIONS

This application is a continuation of U.S. patent application Ser. No. 63/714,976 filed on Nov. 1, 2024, the disclosures of which are hereby incorporated by reference in its entirety.

### FIELD OF THE INVENTION

The present inventive concept relates to the field of water filtration. More particularly, the invention relates to filtration systems designed to deliver more desirable water directly from a source of municipally supplied water, such as a tap, faucet or outdoor spigot, to a standard three to five gallon water jug, while limiting the risk of external contaminants.

### BACKGROUND

Over the past several decades, a wide range of drinking water filtration and treatment systems have been developed to meet the growing demand for clean and improved water. These systems include faucet-mounted filters, reverse osmosis systems, inline filtration systems, and gravity-fed filters. While the specific goals of these devices may vary, they all share a common objective: to enhance water quality by reducing contaminants, altering chemical properties, or improving taste to meet consumer preferences.

Despite the availability of home-based filtration systems, many consumers opt for alternative solutions such as subscribing to water delivery services or using water filling stations to refill large-capacity jugs, typically ranging from three to five gallons. These jugs are often used with water dispensers for convenience. However, both of these approaches come with significant drawbacks.

Water delivery services, while convenient, can be costly and environmentally detrimental. The production and transportation of bottled water contribute to plastic waste and carbon emissions, while recurring fees, contracts, and the need for storage space to house spare water jugs further add to the inconvenience. On the other hand, water filling stations present their own challenges. Hidden costs such as fuel, time, and energy spent traveling to and from the station can add up. Moreover, the cleanliness and maintenance of these stations are critical but not always guaranteed, potentially compromising water safety. Additionally, the physical task of transporting heavy water jugs can be cumbersome and inconvenient for many consumers.

For those who wish to bypass delivery services and filling stations by using their municipally supplied water, there are further obstacles. Municipal water often contains undesirable levels of chlorine, lead, fluoride, or other chemicals, raising concerns about its quality. Additionally, there are currently no ideal solutions on the market to assist consumers in filling large-capacity water jugs at home while protecting the water from external contaminants such as dirt, dust, or airborne particles during the transfer process.

This novel device addresses these challenges by offering a practical, efficient solution. It enables consumers to fill their three to five gallon water jugs directly from a municipal water source, such as a faucet or tap, while ensuring the water is filtered and protected from contamination. This innovative design combines ease of use with enhanced water quality, providing a cost-effective and environmentally friendly alternative to traditional water delivery and filling station methods.

### SUMMARY OF THE INVENTION

The invention relates to a portable water jug filtration system designed to filter tap water before it enters a water jug or similar container. The system includes a filter with a mouthpiece at the top, a connector at the bottom, an attachable hose, and a cap. The hose connects the filter to a kitchen tap, allowing water to flow through the filter and into the jug, where it is purified.

The filter is detachable, with various possible shapes for its top and bottom portions, including but not limited to round, circular, or flat configurations. The cap attaches to both the filter and the water jug, ensuring a secure connection. The cap may also include a vent to release excess pressure and prevent overflow during use.

The filtration system can use different types of filters tailored to specific needs, such as reducing sediment, chlorine, or other contaminants, and can incorporate multiple inline filters for more advanced purification. The materials used for the filtrations system are food-safe and durable, including but not limited to options like polypropylene, polyethylene, and stainless steel.

The system is designed for easy use, with a straightforward assembly that simplifies the filtration process and provides clean, safe drinking water.

### BRIEF DESCRIPTION OF THE DRAWINGS

FIGS. 1A-1B is a front view of the water jug filtration system of the present invention;

FIGS. 1C-1E shows incorporation of multiple inline filters for more advanced purification;

FIGS. 2A-2D is a disassembled view of the filter and a cap of the present invention;

FIGS. 3A-3B is an exemplary view of the water jug filtration system of the present invention.

FIG. 4 is another exemplary view of the water jug filtration system of the present invention

### DETAILED DESCRIPTION

The following description outlines the best mode or modes presently contemplated for the invention. This description is provided solely for illustrative purposes and is not intended to limit the scope of the invention. By referencing this description in conjunction with the accompanying drawings, one skilled in the art can gain insight into the construction and advantages of the invention.

It must also be noted that as used herein and in the appended claims, the singular forms “a”, “an”, and “the” include plural reference unless the context clearly dictates otherwise. Thus, for example, reference to an “organ” is a reference to one or more organs and equivalents thereof known to those skilled in the art, and so forth

The term “water” is used interchangeably with the word “liquid” throughout the description, indicating that the system may be applicable to filtering and purifying various types of liquids, not limited solely to water.

The term “jug” is used interchangeably with “bottle,” “decanter,” “flask,” “jar,” or “container,” indicating that the system can be used with various types of vessels for holding liquids.

The term “filtration” is used interchangeably with “filter,” “filtering,” “filters,” “purify,” “purification,” “clear,” “strain,” “sieve,” and “filtrate,” encompassing all processes and methods involved in removing impurities and contaminants from liquids.

The present invention relates to a portable water jug filtration system 1. The device comprises a filter 2 with a mouthpiece 4 at the top, a connector 3 at the bottom, an attachable hose 6, and an attachable cap 5. The mouthpiece 3 at the top of the filter 1 connects to one end 7 of a hose 6, while the other end 8 of the hose 6 is designed to attach to a kitchen tap 10, faucet, outdoor spigot or similar device for regulating the flow of liquid.

The connector 3 at the bottom of the filter 1 attaches to a removable cap 5, which can then be secured to a jug 11 or other suitable container. As tap 10 water flows through the hose 6 and into the filter 2, the system 1 efficiently filters the water, and delivers clear water to the jug 11, water bottle, or a similar container.

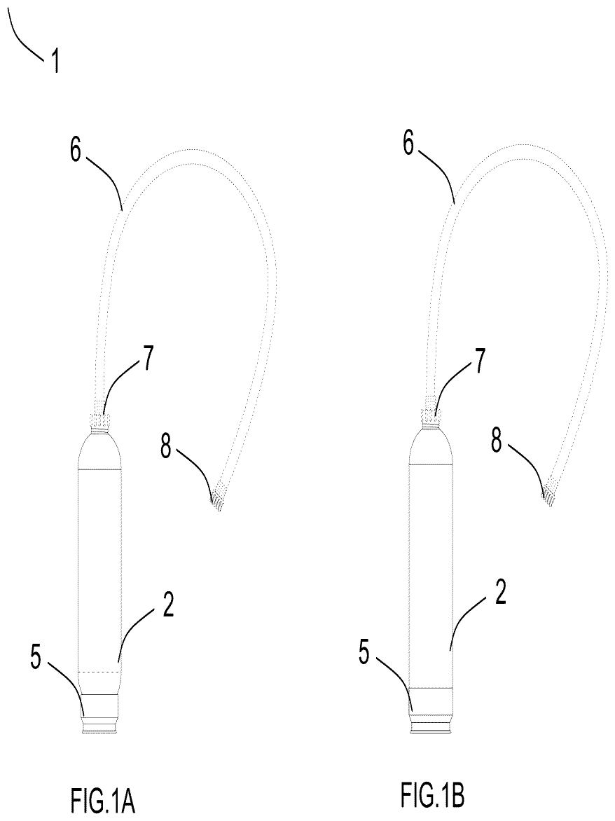

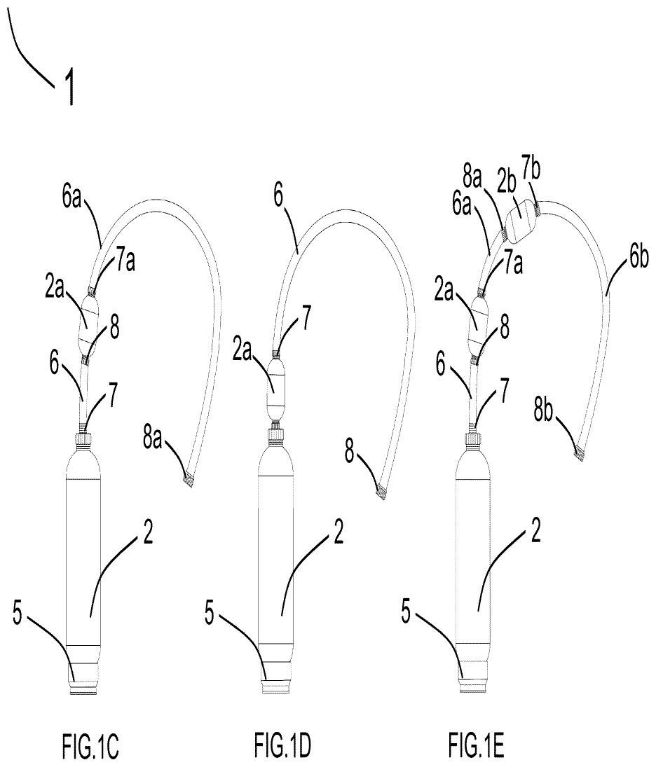

Referring to FIGS. 1A and 1B, a first embodiment of the water jug filtration system 1 is illustrated in accordance with the present invention. The system 1 comprises a filter 2, a detachable hose 6, and a detachable cap 5, all interconnected. The filter 2 connects to the hose 6 at the top via a mouthpiece 4 and the hose's one end 7. At the bottom, the filter 2 attaches to the cap 5 through a connector, creating a secure assembly.

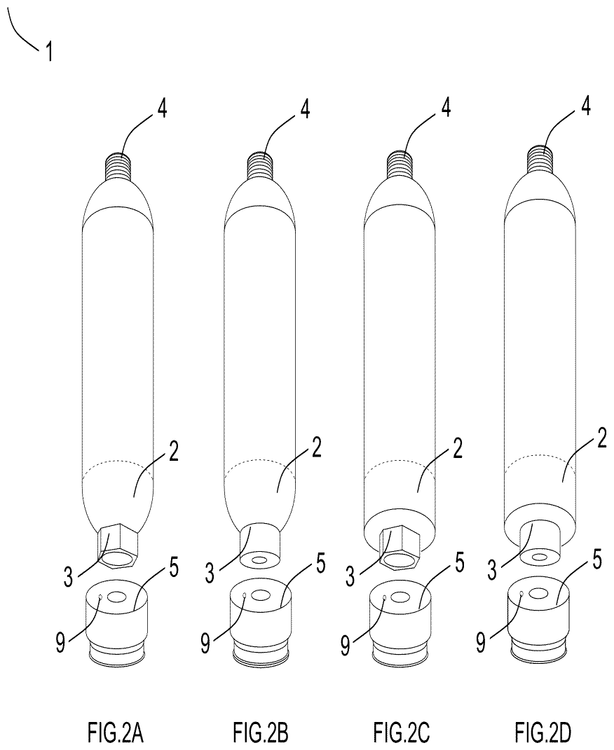

In one embodiment, the top and bottom portions of the filter 2 are round, circular, or cylindrical in shape, though not limited to these configurations (see FIG. 1A and FIGS. 2A-2B). In another embodiment, the top side of the filter 2 may have shapes such as round, circular, or cylindrical, while the bottom side may be flat, plain, or other suitable shapes, without limitation (see FIG. 1B and FIGS. 2C-2D).

FIGS. 1C-1E shows incorporation of multiple inline filters for more advanced purification. The system 1 can incorporate filters of various types, shapes, and functions, making it highly adaptable to different filtration needs. Multiple filters may be used inline, working together to achieve better or more specific outcomes.

In one embodiment, filter 2 and filter 2a are connected using a single hose (6), where one end (7) connects to filter 2 and the other end (8) connects to filter 2a. Additionally, a second hose (6a) is linked to filter 2a at one end (7a), while its other end (8a) is designed to attach to a tap (see FIG. 1C). In an alternative embodiment, filters 2 and 2a are directly connected without the use of hose 6. The second filter (2a) is attached to one end (7) of hose 6, with the other end (8) available for further integration (see FIG. 1D). In yet another embodiment, three inline filters—filter 2, filter 2a, and filter 2b—are connected using at least two hoses, hose 6 and hose 6a. One end (7) of the first hose (6) connects to the first filter (2), while the other end (8) connects to the second filter (2a). Similarly, one end (7a) of the second hose (6a) connects to the second filter (2a), and the other end (8a) connects to the third filter (2b). Additionally, one end (7b) of a third hose (6b) connects to the third filter (2b), while the other end (8b) is either available for further integration or connects to a tap or another water source (see FIG. 1E).

For example, the first filter in the sequence could be designed to reduce sediment, while the second filter might target chlorine removal and taste improvement. Alternatively, a more complex arrangement could include a first filter to reduce chlorine and enhance taste, a second filter to adjust the pH level, and a third inline filter to remove lead, volatile organic compounds (VOCs), and cysts.

FIGS. 2A-2D depicts a disassembled filter 2 and cap 5 designed for use with the present invention. The filter 2 features a mouthpiece 4 at the top and a connector 3 at the bottom. The shape of the connector 3 may vary and is not limited to hexagonal, square, round, or oval configurations.

The cap 5 includes a hole in the center, allowing it to affix securely to the connector on its top side. On its bottom side, the cap 5 is designed to attach to a water jug 11 or a similar container; and a vent 9 or a small open area on any side of the cap that releases excess pressure, preventing overflow and ensuring a steady flow during filtration.

The cap, which enables the filter 2 to attach securely to a water jug 11, can be made from silicone, polypropylene, polyethylene, or other food-safe materials. These materials are selected for their ability to create a sealed connection on the mouth of the water jug 11.

In one embodiment, the bottom side of the filter 2 is round or circular, while the attached connector 3 is hexagonal or square. In another embodiment, both the bottom side of the filter 2 and the attached connector 3 are round or circular.

In a further embodiment, the bottom side of the filter 2 is flat or plain, with the attached connector 3 being hexagonal or square. Alternatively, the bottom side of the filter 2 may be flat or plain, with the attached connector 3 being round or circular. The embodiments described above are illustrative examples and are not intended to limit the scope of the present invention.

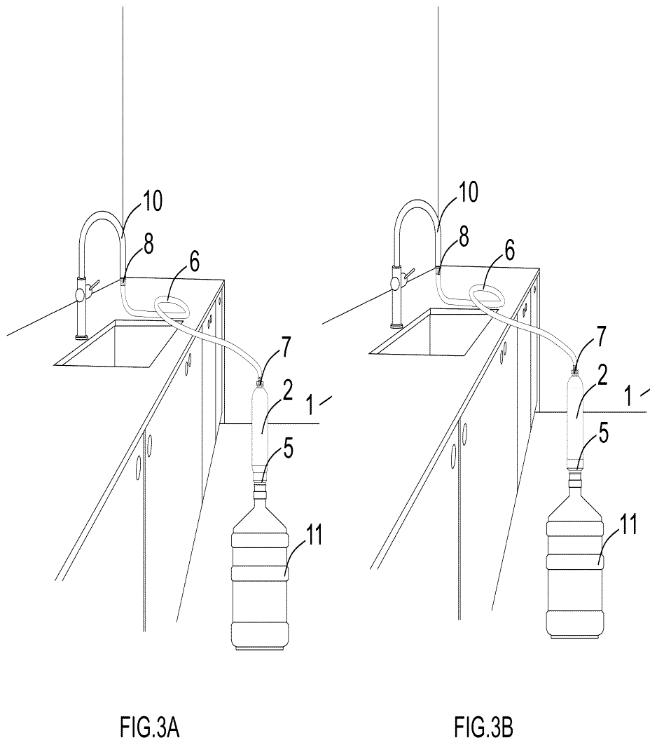

FIGS. 3A-3B illustrate the preferred usage of the water jug filtration system 1, which includes a filter 2, a hose 6, a cap 5, a tap 10, and a water jug 11 or similar container.

At the top of the filter 2, a mouthpiece connects to one end 7 of the hose 6. At the bottom, whether it has a round or circular shape (see FIG. 3A) or a flat or plain surface (see FIG. 3B), a connector 3 of any shape is attached to the filter 2 and securely affixes to the cap 5.

The hose 6 connects to the filter 2 at one end 7, while its other end 8 attaches to a kitchen tap 10, enabling the flow of water. The length of the hose 6 varies.

The cap 5 is designed to join the filter 2 on its top side, while its bottom side attaches to a water jug 11 or a comparable container, ensuring a sealed connection for efficient filtration.

In one embodiment, the cap 5, filter 2, and hose 6 may be manufactured as a single, molded unit, ensuring that these components are inseparable and require no assembly. This integrated design simplifies production and enhances durability by eliminating the need for separate parts. In another embodiment, the cap is designed with a built-in vent 9 to release pressurized air or excess water, ensuring proper functionality and preventing overflow during use.

Using this invention is straightforward and user-friendly. Once the tap 10 or other water source is opened, water flows from the tap 10 and passes through a connected hose 6 into the filter 2; the filtration system 1 efficiently removes impurities and contaminants. The filter 2 is designed to purify the water, ensuring that only clean and filtered water flows into the water jug 11 or a similar container. As water fills the water jug 11, any excess pressure that builds up is released through the vent 9 located in the cap 5. This design prevents overflow and maintains a steady flow during filtration. This process provides the user with safe and clean water, supporting a healthier lifestyle by reducing exposure to potentially harmful substances commonly found in unfiltered water.

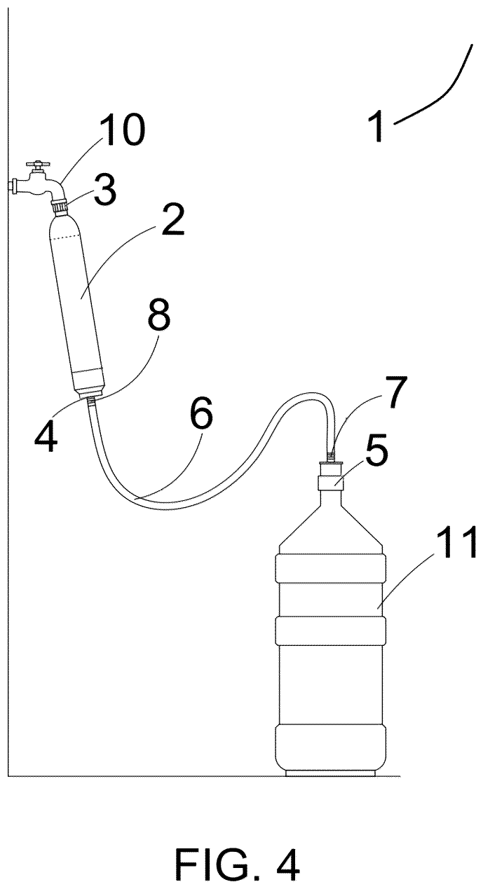

FIG. 4 illustrate an alternative configuration of the water jug filtration system 1, which comprises a filter 2, a hose 6, a cap 5, a tap 10 or any other water source including hose-bib, and a water jug 11 or a similar container.

The system 1 features a connector 3 on the one end of the filter 2, which connects to a tap 10 or any other water source including hose-bib. On the other end, the filter 2 includes a mouthpiece 4 that connects to one end 8 of the hose 6, while the opposite end 7 of the hose attaches to a water jug 11 or an equivalent container, which is securely fitted with the cap 5.

In one embodiment, when the tap 10 or another water source is opened, water flows into the connected filter 2, which is engineered to purify the water by effectively removing impurities and contaminants. The filtered water then travels through a hose 6 and flows into a water jug 11 or a comparable container, which is securely fitted with the cap 5. As the water fills the jug, any excess pressure is released via the vent 9 in the cap 5. This feature prevents overflow and ensures a steady flow throughout the filtration process. By providing safe and clean water, this system promotes a healthier lifestyle by reducing exposure to harmful substances often present in unfiltered water.

The filters or filter housing can be constructed from a variety of materials to suit specific filtration purposes. The filtration media may include activated carbon, micro-porous materials, or other specialized materials designed to reduce sediment, contaminants, and odors, enhance taste, or otherwise treat water for drinking.

The housing materials may include polypropylene, polyethylene, stainless steel, or other food-safe materials suitable for water filtration systems intended for drinking water. These materials are selected for their durability, safety, and compatibility with the intended filtration process.

What is claimed is:

1. A water jug filtration system comprising:
a filter with a mouthpiece and a connector;
a detachable hose;
a detachable cap;
wherein:
said one end of a hose joins with a mouthpiece attached on the top of the filter, and the other to a tap or water source;
a cap affixes to the connector located at the bottom of the filter, and together, they are to be joined with a water jug; and a vent in the cap.

2. The water jug filtration system in accordance with claim 1 wherein the shape of bottom of the filter includes but not limited to flat and round.

3. The water jug filtration system in accordance with claim 1 wherein the shape of the connector includes but not limited to hexagonal and round.

4. The water jug filtration system according to claim 4, wherein two or more inline filters are interconnected via two or more hoses, allowing for enhanced filtration capabilities, including but not limited to sediment removal, pH adjustment, and/or chemical filtration.

5. The water jug filtration system in accordance with claim 4 wherein three or more inline hoses may be connected with three or more inline filters for further advancement of the filtration system.

6. The water jug filtration system in accordance with claim 4 wherein the sizes and shapes of the hose varies.

7. The water jug filtration system in accordance with claim 1 wherein filtration system affixes with containers including but not limited to jug, bottle, and jar.

8. The water jug filtration system in accordance with claim 1 wherein filtration system is portable.

9. A water jug filtration system comprising:
a filter with a mouthpiece and a connector;
a detachable hose;
a detachable cap;
wherein:
said connector of the filter is designed to attach to a tap or water source, while the mouthpiece of the filter connects to one end of a hose; and with the other end connecting to a water jug which is securely fitted with the cap; and a vent in the cap prevents overflow by releasing excess pressure.

10. The water jug filtration system in accordance with claim 9 wherein the shape of bottom of the filter includes but not limited to flat and round.

11. The water jug filtration system in accordance with claim 9 wherein the shape of said connector includes but not limited to hexagonal and round.

12. The water jug filtration system according to claim 9, wherein two or more inline filters are interconnected via two or more hoses, allowing for enhanced filtration capabilities, including but not limited to sediment removal, pH adjustment, and/or chemical filtration.

13. The water jug filtration system in accordance with claim 9 wherein three or more inline hoses may be connected with three or more inline filters for further advancement of the filtration system.

14. The water jug filtration system in accordance with claim 9 wherein the sizes and shapes of the hose varies.

15. The water jug filtration system in accordance with claim 9 wherein filtration system affixes with containers including but not limited to jug, bottle, and jar.

16. The water jug filtration system in accordance with claim 9 wherein filtration system is portable.
